(19) United States
(12) Patent Application Publication
(10) Pub. No.: US 2007/0160724 A1
(43) Pub. Date: Jul. 12, 2007

(54) Preparation of beverage products containing dairy components with enhanced microbial stability

(75) Inventors: Wendy Chan, Chestnut Ridge, NY (US); Carolyn M. Mayerhauser, Ringwood, NJ (US)

Correspondence Address: PEPSICO, INC.;c/o GOODWIN PROCTER LLP, 599 LEXINGTON AVE, NEW YORK, NY, 10022, US

(73) Assignee: PepsiCo, Inc., Purchase, NY (US)

(21) Appl. No.: 11/327,021

(22) Filed: Jan. 6, 2006

(51) Int. Cl. A21D 2/16

(52) U.S. Cl. 426/330

(57) ABSTRACT

A beverage composition and a method of its preparation are provided. The beverage composition contains about 0.1% to about 10% of a milk product, 100 ppm to about 1500 ppm of a polyphosphate, and about 100 ppm to about 1000 ppm of a chemical preservative. The chemical preservative is selected from the group consisting of sorbic acid, benzoic acid, alkali metal salts thereof and mixtures thereof. The beverage composition has a pH in the range of about 2.0 to about 4.5

### TECHNICAL FIELD

The invention relates to a shelf-stable dairy-containing beverage and a method of its preparation.

### BACKGROUND OF THE INVENTION

Calcium is an essential mineral for human consumption. The effects of decreased calcium absorption have been increasingly noticed as the population ages, most notably an increased prevalence of osteoporosis. Calcium has also been found to be useful in fighting obesity. Dairy-containing beverages can be a good source of calcium.

Sodas and juices are available in a wide variety of flavors and are widely consumed. Sodas are generally carbonated. Sodas and juices provide a contrast between sweetness and tang. Thus, there is a need for dairy-containing soda and juice-type beverages with an appealing taste.

Dairy-containing beverages typically have relatively short shelf life. For example, pasteurized milk, perhaps the most popular dairy-containing beverage in the US, has a limited refrigerated shelf life. This increases the cost of milk to consumers because the milk has to be refrigerated throughout its distribution and has to be distributed to consumers in a short time. In addition, it is inconvenient to consumers because milk has to be purchased frequently. On the other hand, sodas and sterilized single strength juices can be purchased several months in advance and stored without refrigeration. The sodas and sterilized juices can be cooled immediately before consumption by adding ice to produce a convenient and refreshing beverage. Thus, there is a need for shelf-stable dairy-containing beverages.

Prior attempts to produce shelf-stable dairy-containing beverages have been largely unsuccessful. The most successful approach to producing shelf-stable dairy-containing beverages is ultra high temperature (UHT) processing. UHT milk is not popular in the US because the UHT processing creates off-flavors foreign to pasteurized milk. UHT milk is more popular outside the US in countries where refrigeration is rarer and pasteurized milk has a very limited distribution. Another possible approach is the use of chemical preservatives. However, the most common chemical preservatives, benzoates and sorbates, also have strong off-flavors at the levels necessary for preservation.

Accordingly, there is a need for an inexpensive method to produce shelf-stable dairy-containing beverages which does not produce off-flavors and which resulting beverage has enhanced microbiological stability.

### SUMMARY OF THE INVENTION

Surprisingly, the Applicants have found that a shelf-stable beverage composition containing a milk product can be produced without sterilization that has enhanced microbiological stability and a pleasing taste. The beverage composition contains a milk product, a polyphosphate and a chemical preservative and has a pH in the range of about 2.0 to about 4.5. The milk product is in an amount of about 0.1% to about 10% by weight of the total beverage composition. The polyphosphate is in an amount of about 100 ppm to about 1500 ppm by weight of the total beverage composition. The chemical preservative is in an amount of about 100 ppm to about 1000 ppm by weight of the total beverage composition. The chemical preservative is sorbic acid, benzoic acid, alkali metal salts thereof or mixtures thereof. Preferred chemical preservatives include sodium sorbate and potassium benzoate.

The beverage composition may also contain a food-safe liquid having a hardness less than about 100 ppm as CaCO₃ by weight of the total beverage composition. The food-safe liquid can be an aqueous beverage within the aforesaid hardness limit, including, for example, juice, water, tea, coffee, and combinations thereof. The food-safe liquid can be a blend of various aqueous liquids.

In another embodiment of the invention, the Applicants have surprisingly found a method of making a non-refrigerated, shelf-stable, dairy-containing beverage composition. The method includes preparing a beverage having a pH of about 2 to about 4.5. The beverage contains a milk product in an amount of about 0.1% to about 10% by weight of a total beverage composition. The method also includes adding a chemical preservative in an amount of about 100 ppm to about 1000 ppm by weight of the total beverage composition. The chemical preservative is sorbic acid, benzoic acid, alkali metal salts thereof or mixtures thereof. The method further includes adding a polyphosphate in an amount of about 100 ppm to about 1500 ppm by weight of the total beverage composition.

### DETAILED DESCRIPTION OF THE INVENTION

The amount of milk product in the finished beverage is less than about 10% by weight. “Milk products” as used herein includes pasteurized milk, cow's milk, raw milk, scalded milk, homogenized milk, dried milk, dry milk, milk powder, powdered milk, evaporated milk, condensed milk, skim milk, skimmed milk, whole milk, low-fat milk, buttermilk, acidified milk, dairy product, and protein obtained from milk. If a concentrated milk is used, e.g. evaporated milk or milk powder, the 10 wt % limit applies to the milk concentrate and not to the reconstituted milk. Milk products can include UHT milk and products derived from UHT milk. However, UHT milk and products are generally not preferred due to their flavor. Acidified dairy base is a milk-based product which has been acidified and homogenized and can contain considerably less than 100% dairy.

Typically, beverages in accordance with the invention after an initial contamination level of about 10-1000 cfu/ml of test spoilage microorganisms exhibit less than a 100 fold increase in the level of test microorganisms when stored at 25° C. and 35° C. over a 20-week period.

Polyphosphates can be any kind of polyphosphates and can be mixtures of different polyphosphates. Preferably the polyphosphates are sodium or potassium polyphosphates and mixtures thereof. More preferably, sodium polyphosphates are used. Preferably, the average chain length of the polyphosphate used ranges from about 6 to about 60 and more preferably from about 6 to about 21. Sodium polyphosphate having a chain length of about 9 to about 15 or from about 17 to about 21 are especially preferred.

Food-safe chelators may also be used to preserve the beverage. Without wanting to be bound by theory, chelators enhance the potentiating effect of polyphosphates by chelating minerals necessary for microbial growth. Food-safe chelators include, but are not limited to, EDTA, particularly sodium EDTA. The US Food and Drug Administration restricts the concentration of EDTA to below 30 ppm by weight.

Chemical preservatives are included in accordance with the invention. The chemical preservative can be sorbic acid, benzoic acid, alkali metal salts thereof and mixtures thereof, typically present in an effective amount, such as about 100 to about 1000 ppm on the basis of the total beverage. Preferred forms include sodium sorbate, sodium benzoate, potassium sorbate and potassium benzoate.

The beverage will generally include an added food-safe liquid. The hardness of the food-safe liquid should be less than about 100 ppm as CaCO₃. Hardness ions include calcium, magnesium, and iron. The amount of food-safe liquid added to the beverage generally depends on the mass of other ingredients. Preferably, the food-safe liquid is water or a juice. The concentration of food-safe liquid generally exceeds about 85% by weight of the total beverage.

The pH of the beverage of the invention is about 2.0 to about 4.5. To achieve this pH, it may be necessary to use pH adjusters. Any food safe pH adjuster may be used. Generally acidulants will be used to obtain the low pH. Suitable pH adjusters include, but are not limited to, phosphoric acid, citric acid, malic acid, lactic acid, tartaric acid, ascorbic acid and combinations thereof. Juices may also be used to acidify the beverage.

Surprisingly the polyphosphate does not substantially precipitate with milk proteins contained in the milk product. In addition, the invention is surprisingly shelf-stable without pasteurization or sterilization despite the high hardness of milk. For example, whole milk contains on average 95 mg/100 g of calcium and 10.1 mg/100 g of magnesium. [VARIABILITY OF MINERALS IN FOODS, http://www.nal.usda.gov/fnic/foodcomp/conf/NDBC21/p6-2.pdf.] Skim milk contains on average 302 mg/8 oz of calcium and 27.8 mg/8 oz of magnesium. [USDA, NUTRIENT PROFILES OF FOOD GUIDE PYRAMID FOOD GROUPS AND SUBGROUPS, available at http://www.usda.gov/cnpp/pyramid-update/FGP%20docs/TABLE%204.pdf.] Thus, the hardness of skim milk and whole milk is approximately 3600 and 2800 ppm as CaCO₃, respectively. As one skilled in the art would recognize, the measurement of hardness is conventionally reported as CaCO₃ because the principal source of hardness in drinking water supplies is often CaCO₃ even though hardness ions, such as Ca²⁺, Mg²⁺ and Fe²⁺, can come from sources other than calcium carbonate.

The surprising shelf stability of the invention becomes even more surprising as the concentration of dairy or hardness increases. For example, the stability becomes increasingly surprising as the dairy concentration exceeds about 2%, about 2.5%, etc. The stability becomes increasingly surprising as the hardness exceeds about 20 ppm, about 40 ppm, about 60 ppm, and about 80 ppm as CaCO₃. The stability is increasingly surprising as the total beverage composition hardness exceeds about 60, about 80 ppm and about 100 ppm as CaCO₃.

However, as the hardness of the total beverage composition increases, increasing levels of preservatives are needed, which may negatively impact the flavor of the beverage. Thus, it is generally preferred that the inventive dairy contain between about 1 and about 3 wt % of the dairy component and that the hardness remains below 100 ppm. Preferably, the food-safe liquid hardness is between about 20 ppm and 80 ppm.

The beverage may be carbonated or non-carbonated. Carbonated beverages generally contain 2 or more volumes of carbon dioxide at standard temperature and pressure.

TABLE I
Inventive Beverage Compositions

| Ingredient | Amount | |
|---|---|---|
| Sweetener as syrup | 130 | g |
| Antifoam agent | 0.28 | g |
| Flavor | 2.8 | g |
| Acidified dairy base | 26.8-53.5 | g |
| | (providing 1.5-3 wt | |
| | % milk product based on | |
| | the total beverage weight) | |
| Polyphosphate | 0-0.15 | g |
| EDTA | 0.03 | g |
| Sodium benzoate | 0-0.535 | g |
| Potassium sorbate | 0-0.14 | g |
| Citric acid | 0-1.3 | g |

| | |
|---|---|
| Water having a hardness of 25 ppm | Fill to 1000 ml. |
| Carbon dioxide | >˜2 volumes of carbonation |

The beverage of the invention may contain many other ingredients, as desired. The selection of ingredients can depend on whether the beverage is meant to be used as a sports beverage, a nutraceutical, a meal replacement, etc. The selection of ingredients may vary based on desired flavors for the beverage. Examples of optional additional ingredients include, but are not limited to, flavors, foaming agents, anti-foaming agents, hydrocolloids, polysaccharides, juices, sweeteners—artificial or natural, caffeine, coffee solids, tea solids, herbs, nutraceutical compounds, electrolytes, vitamins, minerals, amino acids, other preservatives, alcohol, colorants, emulsifiers, and oils as known in the art.

### EXAMPLES

Four different compositions made in accordance with Table I were tested. The compositions were deemed shelf stable as they exhibited less than a 100 fold increase in the level of test microorganisms when stored at 25° C. and 35° C. 287 ml samples from each of the four different compositions were inoculated with 1 ml of either of the following inoculation solutions:

Inoculation Solution 1: Yeast—formulated to provide 1.0×10² colony forming units/ml (cfu/ml) of inoculated beverage.

Inoculation Solution 2: Lactic Acid Bacteria—formulated to provide 1.0×10³ cfu/ml of inoculated beverage.

The samples were tested over 20 weeks. The inoculated samples were appropriately incubated throughout the duration of the test. All test samples had less than a 100 fold increase of the inoculated microorganisms over a 20-week period.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A beverage composition comprising:
(a) a milk product in an amount of about 0.1% to about 10% by weight of a total beverage composition;
(b) a polyphosphate in an amount of about 100 ppm to about 1500 ppm by weight of the total beverage composition; and
(c) a chemical preservative in an amount of about 100 ppm to about 1000 ppm by weight of the total beverage composition, wherein the chemical preservative is selected from the group consisting of sorbic acid, benzoic acid, alkali metal salts thereof and mixtures thereof; the beverage composition having a pH in the range of about 2.0 to about 4.5.

2. The milk product beverage composition of claim 1 further comprising a food-safe liquid having a hardness less than about 100 ppm as CaCO₃.

3. The beverage composition of claim 2 wherein the food-safe liquid is water having a hardness of about 20 ppm to about 80 ppm as CaCO₃.

4. The beverage composition of claim 1 wherein the hardness of the beverage composition exceeds about 60 ppm as CaCO₃.

5. The beverage composition of claim 1 wherein the hardness of the beverage composition exceeds about 80 ppm as CaCO₃.

6. The beverage composition of claim 1 further comprising EDTA in an amount of up to 30 ppm by weight of the total beverage composition.

7. The beverage composition of claim 4 further comprising 2 volumes or more of carbon dioxide.

8. The beverage composition of claim 1 wherein the polyphosphate has a chain length of about 6 to about 60.

9. The beverage composition of claim 7 wherein the polyphosphate has a chain length of about 6 to about 21.

10. The beverage composition of claim 8 wherein the polyphosphate is a sodium polyphosphate.

11. The beverage composition of claim 1 wherein the milk or milk product is pasteurized milk, cow's milk, raw milk, scalded milk, homogenized milk, dried milk, dry milk, milk powder, powdered milk, evaporated milk, condensed milk, skim milk, skimmed milk, whole milk, low-fat milk, buttermilk, acidified milk, goat milk or protein obtained from milk.

12. The beverage composition of claim 1 wherein the milk or milk product is in an amount of about 5% to about 10% by weight of the total beverage composition.

13. The beverage composition of claim 1 wherein the milk or milk product is in an amount of about 7% to about 10% by weight of the total beverage composition.

14. The beverage composition of claim 1 wherein the beverage has a shelf life of about 20 weeks or more when stored at a temperature up to 35° C.

15. The beverage composition of claim 1 wherein the milk or milk product is not derived from UHT milk and the polyphosphate does not substantially precipitate with milk proteins contained in the milk product.

16. A method of making a shelf-stable dairy-containing beverage composition comprising:
(a) preparing a beverage having a pH of about 2 to about 4.5, the beverage composed of a milk product in an amount of from about 0.1% to about 10% by weight of a total beverage composition;
(b) adding a chemical preservative in an amount of about 100 ppm to about 1000 ppm by weight of the total beverage composition, wherein the chemical preservative is selected from the group consisting of sorbic acid, benzoic acid, alkali metal salts thereof and mixtures thereof; and
(c) adding a polyphosphate in an amount of about 100 ppm to about 1500 ppm by weight of the total beverage composition.

17. The method of claim 16 further comprising acidifying the beverage with an acidulant so that the pH of the beverage composition is about 2 to about 4.5.

18. The method of claim 16 wherein the acidulant is selected from the group consisting of citric acid, phosphoric acid, malic acid, tartaric acid, ascorbic acid and combinations thereof.

19. The method of claim 17 further comprising adding a food safe liquid;
wherein the beverage composition has a hardness exceeding about 80 ppm as CaCO₃.

20. The method of claim 19 further comprising adding a food-safe chelator.
